(19) United States
(12) Patent Application Publication
(10) Pub. No.: US 2023/0365776 A1
(43) Pub. Date: Nov. 16, 2023

(54) REGENERATED FOAMED PARTICLES, REGENERATED FOAMED AND MOLDED BODY, AND MANUFACTURING METHOD THEREFOR

(71) Applicant: Sunko Ink Co., Ltd., Taichung City (TW)

(72) Inventors: Ya-Chi Wang, Taichung City (TW); Ting--Kai Huang, Taichung City (TW)

(21) Appl. No.: 18/029,051

(22) PCT Filed: Sep. 29, 2020
(86) PCT No.: PCT/CN2020/119007

§ 371 Date: Mar. 28, 2023

(51) Int. Cl. C08J 9/33; C08J 11/06

(52) U.S. Cl. CPC C08J 9/33; C08J 11/06; C08J 2375/04

(57) ABSTRACT

Regenerated foamed particles, and a regenerated foamed and molded body made from same. The regenerated foamed particles are made by melting and foaming regenerated TPU particles. The regenerated TPU particles are formed by melting and pelletizing a recycled composition which contains 100 parts by weight of scraps of a waste ETPU molded body and 0 to 20 parts by weight of a TPU prepolymer. The regenerated TPU particles have a viscosity of 1,000 to 9,000 poises measured at 170° C. according to the JISK7311 method.

### TECHNICAL FIELD

The present invention relates to regenerated foamed materials made from recycled materials, especially to regenerated foamed particles and regenerated foamed and molded body made from recycled thermoplastic polyurethane.

### BACKGROUND

Expanded Thermoplastic Polyurethane (ETPU) made from foamed thermoplastic polyurethane (TPU) has many advantages, such as ultra-light density, deformation resistance, abrasion resistance, temperature resistance, yellowing resistance, etc., and has been widely used in shoes, automobiles, packaging materials, heat insulation materials, cushioning pads, vibration damping materials, automotive interior materials, tires and other products. In view of the demand for environmental protection, the recycling and reuse of such products have become a trend. For example, the prior art CN111227428A proposes a soles material made of recycled thermoplastic polyurethane. However, there are still problems to be solved in the recycling of such materials in the existing technology.

### SUMMARY

The present invention discovered that not all waste ETPU materials can be successfully recycled to be regenerated into expected products. In particular, for waste ETPU materials that have been aged after being used for a long time or being discarded for a long time, the physical properties thereof have deteriorated significantly, and the results of direct recycling of the waste ETPU materials by melting often deviate from the original characteristics. In addition, the properties of waste ETPU materials are not like new raw materials and often change from batch to batch, resulting in difficult control of quality of the resulting regenerated products. The present invention found that in order to make an expected regenerated foamed and molded body, it is preferable that the waste ETPU materials themselves should be selected or sorted; it is preferable that the waste ETPU materials should be remelted, pelletized and foamed; and it is more preferable that the various conditions of the above-mentioned remelting, pelletizing and foaming process may need to be adjusted depending on the nature or various conditions of the waste ETPU materials, otherwise it is difficult to obtain a successful recycled foamed and molded body.

In view of the above, the present invention provides a method for producing a regenerated foamed and molded body, comprising: melting and pelletizing a recycled composition to obtain regenerated TPU particles, the recycled composition comprising scraps of a waste ETPU molded body; melting and foaming the regenerated TPU particles to obtain regenerated foamed particles; and bonding the regenerated foamed particles through microwaves to form the regenerated foamed and molded body. In one preferred embodiment, the present invention is designed to add an appropriate amount of TPU prepolymer to the recycled composition, with the purpose of producing expected regenerated TPU particles after melting and pelletizing the recycled composition. In one preferred embodiment, the present invention adjusts the content of the TPU prepolymer so that the regenerated TPU particles have a viscosity of 1,000 poise to 9,000 poise, which is measured at 170° C. according to JISK 7311 method.

In one preferred embodiment, the present invention provides regenerated foamed particles, which are made by melting and foaming regenerated TPU particles, and the regenerated TPU particles are formed by melting and pelletizing a recycled composition, and the recycled composition comprises 100 parts by weight of scraps of a waste ETPU molded body and 0 to 20 parts by weight of a TPU prepolymer, the regenerated TPU particles have a viscosity of 1,000 poise to 9,000 poise measured at 170° C. according to JISK 7311 method.

In another preferred embodiment, the present invention provides the aforementioned regenerated foamed particles, wherein the waste ETPU molded body is an article formed by bonding foamed particles through microwave. The foamed particles are different from the regenerated foamed particles.

In another preferred embodiment, the present invention provides the aforementioned regenerated foamed particles, wherein the waste ETPU molded body is composed of foamed particles formed by melting and foaming TPU particles, the TPU particles have a viscosity of 1,000 poise to 9,000 poise, the TPU particles are different from the regenerated TPU particles, and the viscosity is measured at 170° C. according to the JISK 7311 method.

In another preferred embodiment, the present invention provides the aforementioned regenerated foamed particles, wherein the recycled composition comprises 0.1 to 20 parts by weight of the TPU prepolymer.

In another preferred embodiment, the present invention provides the aforementioned regenerated foamed particles, wherein the TPU prepolymer has a NCO content of 3 to 13 weight percent, based on the total weight of the TPU prepolymer, as measured according to ASTM D2572.

In another preferred embodiment, the present invention utilizes new TPU particles to adjust the properties of the recycled foamed composition. In detail, the present invention provides aforementioned regenerated foamed particles, and further comprises melting and foaming a recycled foamed composition, wherein the recycled foamed composition comprises the regenerated TPU particles and TPU particles, and the TPU particles are different from the regenerated TPU particles.

In another preferred embodiment, the present invention adds an anti-wear agent into the recycled foamed composition. Specifically, the present invention provides the aforementioned regenerated foamed particles, and further comprises melting and foaming a recycled foamed composition, wherein the recycled foamed composition comprises the regenerated TPU particles and an anti-wear agent.

In another preferred embodiment, the present invention provides a regenerated foamed and molded body, which is formed by bonding the aforementioned various regenerated foamed particles through microwaves.

In another preferred embodiment, the present invention further blends new foamed particles into the regenerated foamed particles to adjust the properties of the resulting product. In detail, the present invention provides a regeneration foamed and molded body, wherein the regenerated foamed and molded body is formed by jointly bonding the regenerated foamed particles and foamed particles through microwave, the foamed particles are formed by melting and foaming TPU particles, and the foamed particles are different from the regenerated foamed particles

The present invention also includes other aspects and various microwave molded bodies for solving other problems and being combined with the above aspects, as disclosed in detail in the following embodiments.

### DETAILED DESCRIPTION

For fully understanding the present invention and the claims asserted therein, preferred embodiments of the invention will be demonstrated below. The descriptions about well-known components, related materials, and associated processing techniques will be omitted to avoid obscuring the content of the invention.

The manufacturing method of the regenerated foamed and molded body of the present invention comprises the following steps: Step (1) providing a recycled composition, the recycled composition comprising 100 parts by weight of scraps of a waste ETPU molded body and 0 to 20 parts by weight of a TPU prepolymer; Step (2) melting and pelletizing the recycled composition to obtain regenerated TPU particles, the regenerated TPU particles have a viscosity of 1,000 poise to 9,000 poise measured at 170° C. according to JISK 7311 method; Step (3) melting and foaming the regenerated TPU particles to obtain regenerated foamed particles; and step (4) bonding the regenerated foamed particles by microwave to form the regenerated foamed and molded body.

Recycled Composition of Step 1—Waste ETPU Molded Body

Any suitable waste ETPU molded body can be, such as transportation materials, packaging materials, thermal insulation materials, buffer pads, vibration damping materials, automotive interior materials, tires, and other ETPU-based articles. In order to make subsequent regeneration steps easier, when recycling such waste, non-ETPU components of the articles should be removed as much as possible. The waste is then shredded into pieces, preferably to a size of less than 1 cm, by any suitable shredder. In an embodiment, the waste ETPU molded body is obtained from articles made by microwave bonding of foamed particles, such as waste microwave foamed and molded shoes. In a preferred embodiment, the waste ETPU molded body is obtained from an article formed by bonding foamed particles through microwave, the foamed particles are formed by melting and foaming TPU particles, and the TPU particles have a viscosity of 1,000 poise to 9,000 poise, which is measured at 170° C. according to the JISK 7311 method.

Recovery Composition of Step 1—TPU Prepolymer

The TPU prepolymer is an oligomer produced by the reaction of a polyol monomer and a diisocyanate monomer, the TPU polymer has an isocyanate (RNCO) functional group at an end of a polymer chain, wherein R is usually an alkane. The TPU prepolymer has a NCO content of 3 to 13 weight percent, based on the total weight of the TPU prepolymer, as measured according to ASTM D2572. Oligomers have molecular weights in the range of 400 to 10,000 g/mol and are usually polymers consisting of 10-100 or less repeating units. In a preferred embodiment of synthetic TPU prepolymer, the content of diisocyanate monomer is 0.5 to 4.0 equivalents of the polyol monomer. The polyol monomer that can be used in the present invention include polyester polyol monomer, polyether polyol monomer, or mixtures thereof. Polyester polyol is polyester formed from dibasic acid and diol. The diol can have 2 to 10 carbon atoms, and the dibasic acid can be a straight or brunched chain having 4 to 12 carbon atoms. Polyether polyols are polymerized by reacting various initiators with epoxy compounds in the presence of catalysts. The initiator can be low molecular alcohol or amine containing active hydrogen. The epoxy compound may be ethylene oxide or alkyl, aryl, or aralkyl substituted ethylene oxide. Diisocyanate can be selected from 4,4-methylene bis(phenyl isocyanate) (MDI), m-xylylene diisocyanate (XDI), 1,4-phenylene diisocyanate, 1,5-naphthalene diisocyanate, toluene diisocyanate (TDI), isophorone diisocyanate (IPDI), hexamethylene diisocyanate (HDI) and dicyclohexylmethane-4,4-diisocyanate. MDI or TDI is preferable.

Example P: Synthetic TPU Prepolymers

100 parts by weight of polyester polyol (Sunko AR-1400, molecular weight=1000) and 76.5 parts by weight of 4,4-methylenebis(phenyl isocyanate) (MDI) are mixed uniformly at 40° C., and the temperature thereof is increased to 80° C. under continuous stirring and hold constant for 2 hours to yield 176.5 parts by weight of prepolymer (NCO content=9.8 wt %) with a viscosity of 300 poise.

Recycled Composition of Step 1—Proportion of Each Component

In a preferred embodiment, the recycled composition comprises 100 parts by weight of scraps of a waste ETPU molded body and 0 to 20 parts by weight, preferably 0 to 10 parts by weight, and more preferably 0 to 5 parts by weight of TPU prepolymer. When the content of TPU prepolymer exceeds 20 parts by weight, excessive bridging will occur, making it impossible to produce the regenerated TPU particles. When the scraps of the waste ETPU molded body are sufficient to produce regenerated TPU particles with desired viscosity, the recycled composition may be free of TPU prepolymer.

Regenerated TPU Particles of Step 2

The recycled composition can be made into regenerated TPU particles using conventional melt-pelletization techniques. The recycled composition is mixed, melted, and then extruded to form the regenerated TPU particles by using, for example, a single screw extruder or other suitable equipment. There is no particular limit to the shape of the regenerated TPU particles, which can be in the form of beads, flakes/films, strands, chips, etc. The regenerated TPU particles may have the same use as the general TPU particles.

Example of Regenerated TPU Particles of Step 2

Example 1: The waste microwave foamed and molded shoes are collected and shredded into pieces by a shredder. 100 parts by weight of the scraps and 0.5 parts by weight of the prepolymer of Example P (the content of NCO is 9.8 wt %) are mixed uniformly and re-pelletized by a single-screw extruder. To produce the regenerated TPU particles, the rotating speed of the main screw rod is set to 1200 rpm, the metering rotating speed is set to 600 rpm, the temperature of the screw rod and the die head is set to 160° C., and the temperature of the cooling circulating water is set to 10° C. The regenerated TPU particles have a viscosity of 6,000 poise measured at 170° C. according to the JISK7311 method.

Example 2: The waste microwave foamed and molded shoes are collected and shredded into pieces by a shredder. 100 parts by weight of the scraps and 6 parts by weight of the prepolymer of Example P (the content of NCO is 9.8 wt %) are mixed uniformly and re-pelletized by a single-screw extruder. To produce the regenerated TPU particles, the rotating speed of the main screw rod is set to 1200 rpm, the metering rotating speed is set to 600 rpm, the temperature of the screw rod and the die head is set to 160° C., and the temperature of the cooling circulating water is set to 10° C. The regenerated TPU particles have a viscosity of 9,000 poise measured at 170° C. according to the JISK7311 method.

Example 3: The waste microwave foamed and molded shoes are collected and shredded into pieces by a shredder. 100 parts by weight of the scraps and 12 parts by weight of the prepolymer Rubinate 9272 (Huntsman, the content of NCO is 8.4 wt %) are mixed uniformly and re-pelletized by a single-screw extruder. To produce the regenerated TPU particles, the rotating speed of the main screw rod is set to 1200 rpm, the metering rotating speed is set to 600 rpm, the temperature of the screw rod and the die head is set to 160° C., and the temperature of the cooling circulating water is set to 10° C. The regenerated TPU particles have a viscosity of 9,000 poise measured at 170° C. according to the JISK7311 method.

Comparative Example 1: The waste microwave foamed and molded shoes used in Example 1 are collected and shredded into pieces by a shredder. 100 parts by weight of scraps without prepolymer are re-pelletized by a single-screw extruder. To produce the regenerated TPU particles, the rotating speed of the main screw rod is set to 1200 rpm, the metering rotating speed is set to 600 rpm, the temperature of the screw rod and the die head is set to 160° C., and the temperature of the cooling circulating water is set to 10° C. The regenerated TPU particles have a viscosity of 900 poise measured at 170° C. according to the JISK 7311 method. Due to the low viscosity of the regenerated TPU particles of Comparative Example 1, the TPU particles cannot wrap air bubbles in the particles, and therefore the foamed particles cannot be molded, which makes the regenerated foamed particles unable to be formed.

The Step 3 and Step 4 of the above-mentioned embodiment are the steps of forming the regenerated foamed particles and the regenerated foamed and molded body. The manufacture process of this part can also be found in patent TW108112156.

Regenerate Foamed Particles of Step 3

In Step 3, a recycled foamed composition, which comprises the above-mentioned regenerated TPU particles, is melt and foamed. In a preferred embodiment, the recycled foamed composition contains only the regenerated TPU particles. In another preferred embodiment, the recycled foamed composition contains the regenerated TPU particles and the TPU particles, wherein the TPU particles are different from the regenerated TPU particles. The TPU particles may be, for example, any commercially available suitable TPU particles, and the TPU particles preferably have a viscosity of 1,000 poise to 9,000 poise measured at 170° C. according to JISK 7311 method. In addition to the above-mentioned particles, the content of the recycled foamed composition in step 3 may also comprise a thickener, a bridging agent, an anti-wear agent and a foaming agent. The types of anti-wear agent include, but are not limited to, silicone polymers, molybdenum disulfide, polytetrafluoroethylene, calcium carbonate, calcium silicate, kaolin, talc, barium sulfate, mica powder, alumina, silicon oil, glass fiber, zirconium phosphate, and polysiloxane. The anti-wear agent is added at a ratio of 1 to 20 wt % the total weight of the regenerated TPU particles and the TPU particles (if any). The actual practice of step 3 is to pour the recycled foamed composition into a single-screw pelletizer for foaming and pelletizing. The single-screw pelletizer has a die head temperature from 100° C. to 180° C., an extrusion speed from 50 kg/h to 70 kg/h, a die head pressure from 35 kgf/cm² to 65 kgf/cm², and an underwater pelletizing temperature from 10° C. to 20° C. Preferably, the die head temperature of the single-screw pelletizer is from 110° C. to 165° C., more preferably from 110° C. to 150° C.

Example 1A: The regenerated TPU particles of embodiment 1 and TPU particles (trade name: T955PLVM2, having a hardness of 50 Shore A scale and a viscosity of 6,000 poise (170° C.), available from Sunko Ink Co., Ltd) are prepared, wherein the content of TPU particles is 1 to 100 wt % of the total weight of regenerated TPU particles and the TPU particles. 100 parts by weight of the above particles, 2.5 parts by weight of methyl benzoate (as a plasticizer), 2.5 parts by weight of aluminum silicate (as a thickener), 0.1 parts by weight of talc and 15 parts by weight of expandable microspheres (trade name: Expancel 930DU-120, available from Matsumoto, as a foaming agent) are mixed uniformly, poured into the single-screw pelletizer, and then foamed under the following conditions: a material extrusion speed of 50 kg/h, a die head pressure of 50 kgf/cm², a die head temperature of 155° C., a screw rod temperature of 120-170° C., and an underwater pelletizing temperature of 20° C., for obtaining regenerated foamed particles.

Regenerated Foamed and Molded Body of Step 4

In Step 4, the above-mentioned regenerated foamed particles are bonded by microwave to form a regenerated foamed and molded body. The actual practice of Step 4 is to put an appropriate amount of the regenerated foamed particles into a container, and then irradiate with microwaves. The container can be a variety of molds, such as ceramic molds, plastic molds, glass molds or composite molds made from metals and plastics, wherein the preferred one is composite molds made from metals and plastics. In the microwave foaming process, the power of the microwave is preferably from 500 watts (W) to 30,000 W, and more preferably from 5,000 W to 25,000 W at frequency for microwave 2,450 MHz, and the duration of microwave is from 3 seconds to 300 seconds, and more preferably from 5 seconds to 120 seconds. The step of microwave bonding further comprises adding foamed particles to the regenerated foamed particles, wherein the foamed particles are formed by melting and foaming TPU particles, and the foamed particles are different from the regenerated foamed particles.

Example 1B: 100 parts by weight of the regenerated foamed particles obtained in the above-mentioned example 1A are placed in a mold, which has a length of 20 cm, a width of 12 cm, and a height of 1.2 cm. Afterwards, the microwave foaming process is performed under following conditions: a microwave frequency of 2,450 MHz, a microwave power of 8,000 W and a microwave duration of 30 seconds. After the mold is cooled down, the regenerated foamed and molded body is completed. The regenerated foamed and molded body has an average density of 0.27 g/cm³.

Example 2B: 50 parts by weight of the regenerated foamed particles obtained in the above-mentioned example 1A and 50 parts by weight of new foamed particles (Please provide the trade name) are mixed and placed in a mold, which has a length of 20 cm, a width of 12 cm, and a height of 1.2 cm. Afterwards, the microwave foaming process is performed under following conditions: a microwave frequency of 2,450 MHz, a microwave power of 8,000 W and a microwave duration of 30 seconds. After the mold is cooled down, the thermoplastic polyurethane microwave molded body is completed. The regenerated foamed and molded body has an average density of 0.27 g/cm³.

Various examples are given above to illustrate the embodiments of the present invention in detail. Those skilled in the art can easily understand the advantages and effects achieved by the present invention through the content of this specification, and make various modifications and changes without departing from the spirit of the present invention to implement or apply the content of the present invention.

1. Regenerated foamed particles, wherein the regenerated foamed particles are made by melting and foaming regenerated TPU particles, and the regenerated TPU particles are formed by melting and pelletizing a recycled composition, and the recycled composition comprises 100 parts by weight of scraps of a waste ETPU molded body and 0 to 20 parts by weight of a TPU prepolymer, the regenerated TPU particles have a viscosity of 1,000 poise to 9,000 poise measured at 170° C. according to JISK 7311 method, wherein the TPU prepolymer is an oligomer produced by reaction of a polyol monomer and a diisocyanate monomer, and the TPU prepolymer has an isocyanate (RNCO) functional group at an end of a Polymer chain and R is an alkane, the TPU prepolymer has a NCO content of 3 to 13 weight percent based on the total weight of the TPU prepolymer as measured according to ASTM D2572.

2. The regenerated foamed particles according to claim 1, wherein the waste ETPU molded body is an article formed by bonding foamed particles through microwave, and the foamed particles are different from the regenerated foamed particles.

3. The regenerated foamed particles according to claim 1, wherein the waste ETPU molded body is composed of foamed particles formed by melting and foaming TPU particles, the TPU particles have a viscosity of 1,000 poise to 9,000 poise, the TPU particles are different from the regenerated TPU particles, and the viscosity is measured at 170° C. according to the JISK 7311 method.

4. The regenerated foamed particles according to claim 1, wherein the recycled composition comprises 0 to 10 parts by weight of the TPU prepolymer.

5. The regenerated foamed particles according to claim 1, wherein the recycled composition comprises 0 to 5 parts by weight of the TPU prepolymer.

6. The regenerated foamed particles according to claim 1, wherein the recycled composition comprises 0.1 to 20 parts by weight of the TPU prepolymer.

7. The regenerated foamed particles according to claim 1, further comprising melting and foaming a recycled foamed composition, the recycled foamed composition comprising the regenerated TPU particles and TPU particles, the TPU particles being different from the regenerated TPU particles.

8. The regenerated foamed particles according to claim 7, further comprising melting and foaming a recycled foamed composition, the recycled foamed composition comprising the regenerated TPU particles and an anti-wear agent.

9. (canceled)

10. A regenerated foamed and molded body is formed by bonding the regenerated foamed particles according to claim 1 through microwave.

11. The regenerated foamed and molded body according to claim 10, wherein the regenerated foamed and molded body is formed by jointly bonding the regenerated foamed particles and foamed particles through microwave, and the foamed particles are formed by melting and foaming TPU particles, the foamed particles are different from the regenerated foamed particles.
